(19) United States
(12) Patent Application Publication
(10) Pub. No.: US 2012/0282913 A1
(43) Pub. Date: Nov. 8, 2012

(54) REMOTE ACTION SYSTEM FOR A VEHICLE

(75) Inventors: Roland Kaindl, Haimhausen (DE); Tobias Baur, Munchen (DE)

(73) Assignee: Webasto AG, Stockdorf (DE)

(21) Appl. No.: 13/318,963

(22) PCT Filed: Nov. 18, 2010
(86) PCT No.: PCT/DE2010/001355

§ 371 Date: Dec. 14, 2011

(30) Foreign Application Priority Data
Jan. 29, 2010 (DE) 10 2010 006 149.2

(51) Int. Cl. H04W 4/04; H04W 88/02

(52) U.S. Cl. 455/420; 455/566

(57) ABSTRACT

The invention relates to a remote action system for a vehicle, comprising a first functional unit of the vehicle and a mobile data terminal having a first application module, which is designed to be loaded onto the mobile data terminal and installed there by a user, to provide the user with a preferably graphical user interface adapted to the first functional unit, and to exchange data with the first functional unit by means of at least one mobile communication channel. Thus, a mobile telephone or smartphone having an app can be used a remote control of an air conditioner.

The present invention relates to a remote action system for a vehicle, comprising a first functional unit of the vehicle and a mobile data terminal. The invention also relates to a vehicle having a remote action system.

Vehicles are transport devices which can be moved by means of a motor. Thus, vehicles notably include motor vehicles and vessels, but also, for example, airplanes or helicopters.

Vehicles comprise a plurality of functional units, for example, a motor, a vehicle battery or also functional units for comfort applications, such as a vehicle air conditioner, auxiliary heating, seat heating, an electrical seat position adjusting unit, or also a convertible top or sliding roof.

A remote action system is a system which allows a user of the system to perform information retrieval or remote control of a functional unit of the vehicle over large distances between the user and the vehicle. A remote action system may, for example, provide for use of the functional unit or vehicle component via a remote control. Notably for comfort application, remote controls are available which allow changing an operational setting of the functional unit, for example, to automatically open a convertible top or to activate a vehicle air conditioner. In doing so, each of the comfort systems is, in many cases, controlled by a distinct remote control, wherein each of these provides different functions, respectively.

A remote control is usually explicitly adapted to a particular application and is often not available independently of the device for which the remote control is provided. In contrast, other hand devices such as mobile telephones are available to very many people at any time. Modern mobile telephones often include further interfaces in addition to an interface to the mobile communication network, for example, to connect the mobile telephone to a computer over a short distance by wire or wireless, i.e., via an air interface. Mobile telephones, for instance, smart phones such as the Apple iPhone, allow installing user software (“apps”) which are free or subject to costs for different functions, for instance, for music title recognition or also for using the mobile telephone as a remote control for PC software via the PC's WLAN interface (wireless local area network).

Functional units of a vehicle are in some cases designed to make status information available via an air interface outside the vehicle, for example, to render the data accessible to an error diagnosis system.

For example, in DE 10 2008 022 771 (A1), a system for transmitting vehicle diagnosis data to an internet server via a Bluetooth-capable mobile telephone is shown. Diagnosis data which characterize the status of components of a vehicle are transferred to a mobile telephone of a hands-free system of the vehicle via a Bluetooth interface. The mobile telephone is then used to transmit data to an internet server of a service provider which can then inform the user in case a vehicle component needs to be serviced.

Functional units of a vehicle may also be remote controlled via telephone communications via a mobile wireless network.

In DE 42 27 658 C1, it is shown that a vehicle air conditioner may be controlled also over large distances by means of control signals which are generated on the basis of instructions in the form of instructions codes or speech instructions from a distant telephone conveyed to a mobile telephone situated in the vehicle.

In DE 101 52 44 A2, it is shown that laptops, organizers, or a combination of an organizer and a mobile telephone may serve to remotely control a vehicle additional device via a wireless link.

It is an object of the present invention to enable a user to access data in a functional unit of a vehicle in a comfortable manner over large distances using a mobile data terminal which the user can configure himself.

This object is solved by the features of the independent claims. Further advantages, designs, and embodiments of the invention are set forth in the dependent claims.

In accordance with the invention, a remote action system for a vehicle is proposed which comprises a first functional unit of the vehicle and a mobile data terminal having a first application module designed to be loaded onto the mobile data terminal and to be installed there by a user, to provide the user with a preferably graphical user interface adapted to the first functional unit and to exchange data with the first functional unit via at least one mobile communication channel. The user may thus have direct access to data such as current operational parameters and settings without any interface service centers or remote servers which request the data for the user and evaluate them. For this purpose, the user himself sets up a mobile data terminal having an application module provided to him by, for example, the manufacturer of the functional unit. To this end, the mobile data terminal is designed to connect to an internet service via a gateway to a mobile communication network and to download the application module from a server using internet communication protocols. The user may select, set up, and extend the data terminal himself. In a further embodiment, the mobile data terminal includes at least one further interface, for instance, an air interface or a port for a cable link. The application module can thus be loaded onto the mobile data terminal via a mobile communication channel or via a wired interface or another air interface of the data terminal, for instance, via an infrared, Bluetooth, ZigBee, WLAN, or USB (universal serial bus) interface.

The mobile data terminal preferably comprises a touch-sensitive screen by means of which a user interface of the first application module is provided. The user may thus be provided with a graphical interface which can be used in an intuitive manner. For example, user control components of a functional unit may be represented in graphical form which the user then actuates with a finger, pencil or any other suitable input object.

A data terminal which is mobile or portable enables a user to directly establish a mobile communication link himself at any time via at least one channel of a mobile communication network to at least one functional unit of the vehicle and to exchange data with the functional unit via the mobile communication link and to administrate received data on the terminal. The exchange of the data may be unidirectional or bidirectional. For a bidirectional communication, the same mobile communication channel may be used, for example, or a distinct channel for each transmission direction. In this respect, a channel is an available transmission resource of the transmission medium or the communication network, for example, certain slots of a time division multiple access method or a particular frequency range reserved for the transmission.

In contrast to the use of air interfaces for close range data transmission, i.e., a few centimeters up to a few hundred meters, for example, WLAN, Bluetooth, or ZigBee interfaces, the use of a mobile communication channel of a mobile communication network, for example, of a cellular mobile communication network, allows remote action over nearly any large distance, provided that the selected mobile communication network is available. The mobile communication network via which the at least one mobile communication channel is made available may, for example, be a GSM (global system for mobile communication) or a UMTS (universal mobile telecommunications system) network where, for instance, a data transmission service such as GPRS (general packet radio service) or EDGE (enhanced data rates for GSM evolution), HSDPA (high speed downlink packet access) may be used. The mobile data terminal and the functional unit of a vehicle or the vehicle centralized for a plurality of functional units which may, for example, be connected via a vehicle-internal network, such as a CAN (controller area network), include an interface or a gateway to the mobile communication network according to the mobile communication network used.

A direct link exists if data are exchanged between the first mobile terminal and the functional unit. This includes the at least one mobile communication signal being realized using the mobile communication infrastructure of a communication network provider.

An application module or application or “app” of the mobile data terminal may, for example, be a sequence of instructions or a software module or an algorithm executed by a processor of the mobile data terminal to enable a particular application functionality on the data terminal.

The mobile data terminal is preferably a mobile telephone. A mobile telephone is suitable for taking along with the user of the remote action system when leaving the vehicle. Furthermore, a mobile telephone provides the user with further functionalities, not least the functionality of speech communication by telephone. A mobile telephone may notably be a smart phone, for example, an Apple iPhone. This new generation of mobile telephones unites the functionalities of an organizer with those of a mobile telephone in one device. Software application may be installed on the device, enabling access to various functionalities and interfaces of the device using the device's operating system.

In accordance with an embodiment of the invention, the first application module is designed to receive at least one status information of the first functional unit via the at least one mobile communication channel. For instance, an air conditioner may thus transmit current operational parameters, such as the vehicle interior temperature, the activation state, or the set target temperature. Or, for instance, the state of a top of a convertible vehicle, for example, closed/open, may be transmitted. The charging status of a vehicle battery may also be received.

It is particularly preferred that the first functional unit is designed to automatically transmit the at least one status information to the first application module via the at least one mobile communication channel in dependence on at least one current status value of the first functional unit. In this manner, the functional unit from which, for instance, an operational parameter is to be transmitted to the data terminal, can do this in a “push” mode without waiting for a request from the application module of the mobile data terminal (“pull” mode). For instance, a malfunction or operation of a functional unit of the vehicle beyond previously configured critical value can thus be reported. In an embodiment in which the vehicle is an electrical car, a notification may thus be sent automatically to the mobile data terminal when the charging operation of the vehicle is terminated and the battery is accordingly fully loaded. This is notably advantageous because the batteries of today's electrical cars require charging periods of several hours after a heavy discharge, which the user may thus better use for other things.

It is advantageous if the first application module is designed to set at least one operational setting of the first functional unit. In addition to initiating status requests, the system is suitable to change the operational setting of a functional unit by remote control using the at least one mobile communication channel. If the functional unit is, for example, an air conditioner or an auxiliary heating of the vehicle, the user may start the air conditioning process by means of an application module of a mobile data terminal, possibly long before the user goes to the vehicle himself. In the same manner, he can select parameters such as the target temperature, the conditioning time, or a particular operating mode.

In a particular embodiment of the remote action system, the mobile data terminal comprises a reception unit for positional data, and the first application module is designed to set the at least one operational setting of the first functional unit when a distance of a position of the mobile data terminal from a position of the vehicle reaches a critical value. The positional data are determined from data received from a position determining system, for instance, the Global Positioning System (GPS). The critical value for which the operational setting of the functional unit is set when the critical value is reached may be configured beforehand. Determining a distance requires the position of the vehicle to be known too.

To this end, the user may, for example, capture the position of the vehicle using a reception unit of the mobile data terminal when parking the vehicle and save it in the data terminal. In another embodiment, the vehicle also includes a reception unit for positional data and is designed to transmit these to the mobile data terminal via the at least one mobile communication channel.

For instance, an auxiliary heating or air conditioning of the vehicle may thus be automatically activated when falling below the critical value or switched off when exceeding the critical value. In the same manner, other current-consuming functional units may, for example, be deactivated when the user departs with the data terminal, or an alarm system may be activated.

This notably allows automatic transmission of the user's personal settings from the user's data terminal to the functional unit for activating settings saved in a functional unit, for instance, re-establishing a programmed seat position of the driver or the desired temperature or the position of, for instance, back mirrors which were previously moved by other users, for example, when approaching the vehicle.

In a further embodiment, the vehicle comprises a second reception unit for positional data. The positional data captured by the vehicle can be transmitted to the mobile data terminal via the at least one mobile communication channel. By means of maps saved there or by accessing maps available on the Internet, the vehicle's position can be indicated to the user. If the mobile data terminal includes the first reception unit for positional data, navigational indications may thus be displayed on the mobile data terminal for the user as to how he best reaches his vehicle. It is therefore advantageous if the mobile data terminal enables access to the internet via which servers with maps, such as Google Earth from the Google company, are accessed for visualization.

If the mobile wireless network is a cellular mobile wireless network, it may be envisioned in a further embodiment to determine the position of the vehicle using the identification number of the cell in which the vehicle is located.

In an embodiment, it may be envisioned that the remote action system comprises at least one further data terminal, wherein setting the at least one operational setting is performed individually in dependence on which one of the data terminals has the position at which the distance reaches the critical value. As each data terminal is unambiguously identifiable, in case of a mobile telephone link using the telephone number, for instance, it is thus possible to individually activate the user's settings for a functional unit for each user of a mobile data terminal, depending on which user among the users identified by their data terminals approaches the vehicle.

Furthermore, the remote action system may comprise at least one further functional unit. The remote action system may thus comprise, for example, not only alternatively the functional units mentioned by way of example, but several ones or all of them simultaneously. The mobile data terminal may thus serve as a master remote control for a plurality of functional units, for instance, comfort systems. The necessary number of remote controls for different systems is thus reduced.

In this respect, the first application module may be designed to allow data communication with all functional units. This requires, depending on the number of functional units, a possibly elaborate implementation of the application module. If a manufacturer does not want to provide an adapted application module for each possible combination of functional units, but instead only a single module, this, under circumstances, then includes components which may be unnecessary for a vehicle having only a selection of all possible functional units.

The mobile data terminal preferably comprises at least one further application module designed to exchange data with the at least one further functional unit via the at least one mobile communication channel. The mobile data terminal offers a unified platform for different use applications or application modules. By providing a further application module or an application module for each functional unit or groups of functional units, it is possible that the mobile terminal uses several less complex application modules successively or also simultaneously. This allows for an optimized use of the resources of the mobile hand device, for example, of memory or processor capacities. Furthermore, adding or removing and a simple exchange of application modules by newer versions are thus made possible.

In a further embodiment, it is envisioned that the first application module is designed to exchange data with the first and the at least one further functional unit via the at least one mobile communication channel. In this manner, it is, for example, possible to interlink the pieces of information provided by several functional units in a simple manner and, as the case may be, to produce a synergetic effect because data exchange between application modules of the data terminal is avoided or reduced. For instance, if a vehicle includes a solar module functional unit by means of which energy is generated from sunlight, a standby ventilation functional unit, and an onboard battery functional unit, the user has the possibility to decide to use the energy generated by the solar module either for the standby ventilation or for charging the onboard battery or proportionally for both.

In a further embodiment, it is furthermore envisioned that the first functional unit is designed to receive instructions from the application module and to send instructions to the at least one further functional unit. To this end, an onboard network connecting the functional units may, for example, be used. In this manner, it is possible to control different functional units, which, for example, originate from the same manufacturer using the mobile data terminal even if the gateway to the mobile wireless network is only directly integrated in one of the functional units and not accessible via an onboard network for other functional units.

Furthermore, a vehicle having a remote action system in accordance with one of the described embodiments is provided according to the invention. In this manner, the advantages and peculiarities of the remote action system according to the invention are also implemented within the framework of a vehicle.

The invention will now be explained by way of example by making reference to the accompanying drawings on the basis of a preferred embodiment.

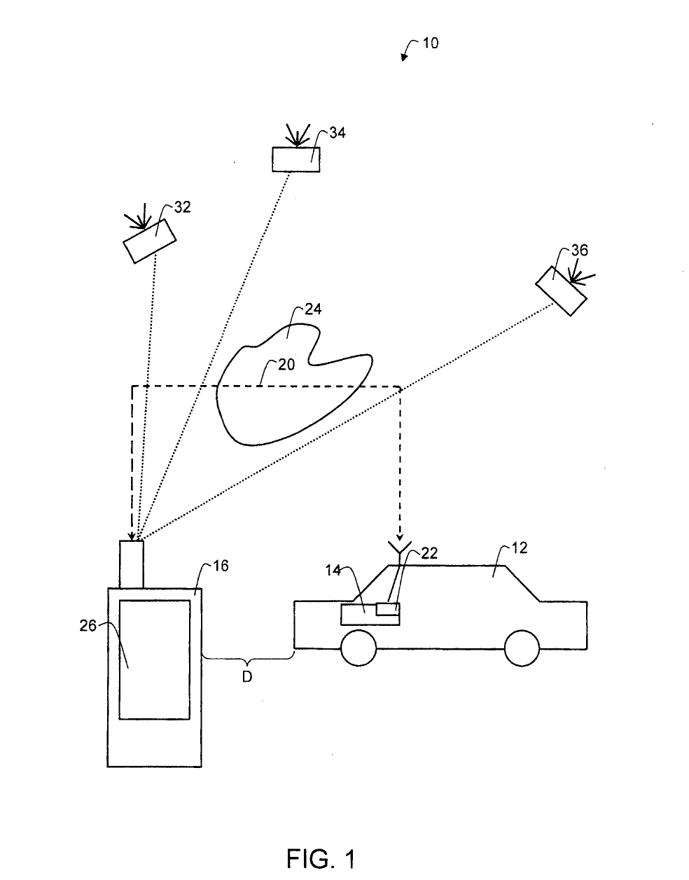

FIG. 1 shows a schematic representation of an embodiment of a remote action system for a vehicle according to the invention;

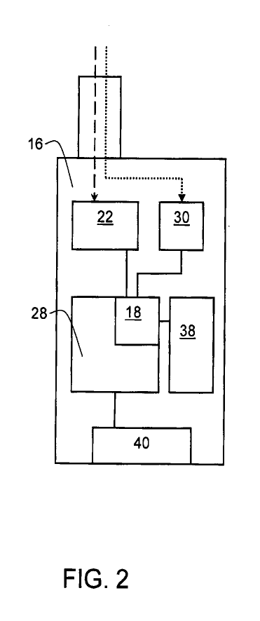

FIG. 2 shows a schematic representation of a mobile data terminal.

In the following description of the drawings, identical reference numerals identify identical or comparable components.

FIG. 1 shows a schematic representation of an embodiment of a remote action system 10 according to the invention for a vehicle 12. The vehicle 12 has a functional unit 14, for example, a comfort system, e.g., an air conditioner. The functional unit includes or is connected to a gateway 22, for example, a GSM or UMTS gateway via which data from a mobile communication channel 20 are received and via which they are sent. The mobile communication channel 20 is part of a mobile communication network 24. The functional unit 14 is connected to an application module of a mobile data terminal 16 via the mobile communication channel 20. In the shown embodiment, the mobile data terminal 16 is a mobile telephone, more precisely, a smart phone. The smart phone calls via a pressure or touch-sensitive screen (“touch screen”) by means of which a user can make input into a user interface of an interface of an application module implemented on the mobile data terminal 16, wherein inputs cause the application module to transmit these data or associated instructions via the mobile wireless link 20 to the functional unit 14, for example, the vehicle air conditioner.

In the following, additional reference is made to FIG. 2 which shows a schematic representation of a mobile data terminal 16. The shown mobile data terminal 16 has a gateway 26 to the mobile communication channel 20. The mobile data terminal 16 comprises one or more processors 28. The application module 18 here forms a part thereof or is implemented thereon. In the shown embodiment, the mobile data terminal further comprises a reception module 30 for receiving positional data from satellites 32, 34, 36 of the Global Positioning System (GPS) or from another position determining system. From these data, the mobile data terminal computes its current position. The position of the vehicle 12 is known because it was determined beforehand when the mobile hand device 16 was located in the vehicle 12. The position value is saved in a memory 38 of the data terminal 16. In an embodiment, the vehicle also includes a reception unit for position determination and transmits it into the mobile data terminal via the mobile communication channel.

From the positional data, the distance D between the vehicle 12 and the mobile data terminal 16 is determined. If this distance is reduced and falls below a critical value, configurational settings which were previously input via the touch screen 26 and also saved in the memory 38 are transmitted to the functional unit 14, which in the present example is the air conditioner, via the communication channel 20, for example, to switch on the air conditioner. If the distance D increases and exceeds the critical value, other configurational settings are transmitted, for example, for switching off the air conditioner.

In addition, the mobile data terminal 16 has a further interface 40, for example, a USB,

WLAN, Bluetooth, or ZigBee interface via which, for example, data for installing an application module can be loaded. Moreover, it is possible to download data such as maps for navigation from a server accessible via the internet and to which access is also provided via the mobile communication network.

The features of the invention disclosed in the preceding description, in the drawings, and also in the claims may be important for realizing the invention both individually and in any combination.

### LIST OF REFERENCE NUMERALS

10 Remote action system
12 Vehicle
14 Functional unit
16 Mobile data terminal
18 Application module
20 Mobile communication channel
22 Mobile wireless gateway
24 Mobile communication network
26 Touch-sensitive screen
28 Processor
30 Reception unit for positional data
32 GPS satellite
34 GPS satellite
36 GPS satellite
38 Memory
40 Further interface

1. Remote action system for a vehicle, comprising a first functional unit of the vehicle and a mobile data terminal having a first application module , which is designed to be loaded onto the mobile data terminal and to be installed there by a user, to provide the user with a preferably graphical user interface adapted to the first functional unit and to exchange data with the first functional unit via at least one mobile communication channel.

2. The remote action system of claim 1, wherein the mobile data terminal comprises a touch sensitive screen by means of which a user interface of the first application module is provided.

3. The remote action system of claim 1, wherein the mobile data terminal is a mobile telephone.

4. The remote action system of claim 1, wherein the first application module is designed to receive at least one status information of the first functional unit via the at least one mobile communication channel.

5. The remote action system of claim 4, wherein the first functional unit is designed to transmit the at least one status information to the first application module automatically in dependence on at least one current status value of the first functional unit via the at least one mobile communication channel.

6. The remote action system of claim 1, wherein the first application module is designed to set at least one operational setting of the first functional unit.

7. The remote action system of claim 6, wherein the mobile data terminal comprising a first reception unit for positional data and the first application module is designed to set at least one operational setting of the first functional unit when the distance of a position of the mobile data terminal from a position of the vehicle reaches a critical value.

8. The remote action system of claim 1, wherein the vehicle comprises a second reception unit for positional data.

9. The remote action system of claim 6, further comprising at least one further data terminal, said setting of the at least one operational setting being performed individually in dependence on which one of the data terminals has the position at which the distance reaches the critical value.

10. The remote action system of claim 1, further comprising at least one further functional unit.

11. The remote action system of claim 10, wherein the mobile data terminal comprises at least one further application module which is designed to exchange data with the at least one further functional unit via the at least one mobile communication channel.

12. The remote action system of claim 10, wherein the first application module is designed to exchange data with the first and the at least one further functional unit via the at least one mobile communication channel.

13. The remote action system of claim 10, wherein the first functional unit is designed to receive instructions from the first application module and to send instructions to the at least one further functional unit.

14. A vehicle having a remote action system of claim 1.
